(19) United States
(12) Patent Application Publication
(10) Pub. No.: US 2016/0031405 A1
(43) Pub. Date: Feb. 4, 2016

(54) AIRBAG

(71) Applicant: TK HOLDINGS INC., Auburn Hills, MI (US)

(72) Inventor: Edgar Fernando GARCIA, Torreon (MX)

(73) Assignee: TK HOLDINGS INC., Auburn Hills, MI (US)

(21) Appl. No.: 14/813,943

(22) Filed: Jul. 30, 2015

Related U.S. Application Data
(60) Provisional application No. 62/031,349, filed on Jul. 31, 2014.

(51) Int. Cl. B60R 21/2338

(52) U.S. Cl. CPC B60R 21/2338; B60R 2021/23382

(57) ABSTRACT

An airbag module for protecting an occupant of a vehicle. The module includes an inflatable airbag. The airbag includes a front panel configured to contact the occupant when the airbag is deployed and a rear panel including an opening. The front panel and the rear panel may be connected together along the periphery of each of the panels. The module includes an inflator for providing gas to inflate the airbag. The inflator being positioned in the opening so that inflation gas escapes the inflator into the airbag. The tether includes a strap connected at a second end to the front panel and at a first end at a location proximate to the inflator. The tether is connected to the front panel by a curved seam elongated in one direction.

### CROSS-REFERENCE TO RELATED APPLICATION

The present application claims priority to and the benefit of U.S. Provisional Patent Application No. 62/031,349, filed Jul. 31, 2014. The foregoing provisional application is incorporated by reference herein in its entirety.

### BACKGROUND

The present application relates generally to the field of airbag modules. More specifically, the present application relates to a driver side front airbag (DAB) module having a tether connected to a panel of the cushion with an improved stitched seam.

An inflatable airbag that uses an inflation device that generates gas through pyrotechnic ignition, stored gas or combination thereof typically requires diffusion of the gas into an airbag cushion to properly inflate the cushion and preserve the integrity of the cushion fabric. In a typical inflatable airbag, the inflation device ignites to burn a solid propellant, which turns to gas in order to inflate the airbag cushion. The airbag may include an internal tether that is configured to limit the rearward expansion (e.g., in a direction towards a driver of a vehicle) of the airbag cushion.

Current airbags include a tether that is coupled to the front panel with a circular sewn seam. A reinforcement panel may be provided such that the circular sewn seam couples together three layers of fabric. The inflation forces on the airbag cushion during deployment can result in stress concentrations at the circular sewn seam, which could potentially degrade airbag performance.

### SUMMARY

An embodiment of an airbag module is disclosed herein. The airbag module is configured for protecting an occupant of a vehicle and includes an inflatable airbag. The airbag may include a front panel configured to contact the occupant when the airbag is deployed and a rear panel. The rear panel may include an opening for receiving inflation gas and or an inflator. The front panel and the rear panel may be integrally formed or connected together along the periphery of each of the panels by a seam such as a stitched seam. The module includes an inflator for providing gas to inflate the airbag. A tether for restraining the deployment of the airbag is provide in the interior of the inflatable chamber of the airbag. The tether includes a strap connected at a first end at a location proximate to the inflator and at a second end to the front panel.

The tether is connected to the front panel by a curved seam elongated in one direction. The elongated seam reduces the stress concentrations from those associated with circular seams. The seam connecting the tether to the front face may be a closed curve that is elongated in one direction. The airbag may include a reinforcement panel positioned between the second end of the tether and the front panel. The reinforcement panel may be integrally formed with the second end of the tether and the tether may be folded over between the second end and the reinforcement panel so that the reinforcement panel is positioned between the second end and the front face. The reinforcement panel may be connected to the front panel by the same seam as the tether.

It is to be understood that both the foregoing general description and the following detailed description are exemplary and explanatory only, and are not restrictive of the invention as claimed.

### BRIEF DESCRIPTION OF THE DRAWINGS

Features, aspects and advantages of the present invention will become apparent from the following description and the accompanying exemplary embodiments shown in the drawings, which are briefly described below.

FIG. 1 is a schematic perspective view of a vehicle interior.

FIG. 2 is a schematic side view of a vehicle interior, illustrating an inflated driver front airbag module, according to an exemplary embodiment.

FIG. 3 is a schematic side cross-section view of the airbag module of FIG. 2.

FIG. 4 is a view of the exterior of the airbag cushion, showing a pair of elongated seams configured to couple tethers to the airbag cushion.

FIG. 5 is a top view of the elongated seam of FIG. 4.

FIG. 6 is a view of the interior of the airbag cushion, showing the elongated seams of FIG. 4.

### DETAILED DESCRIPTION

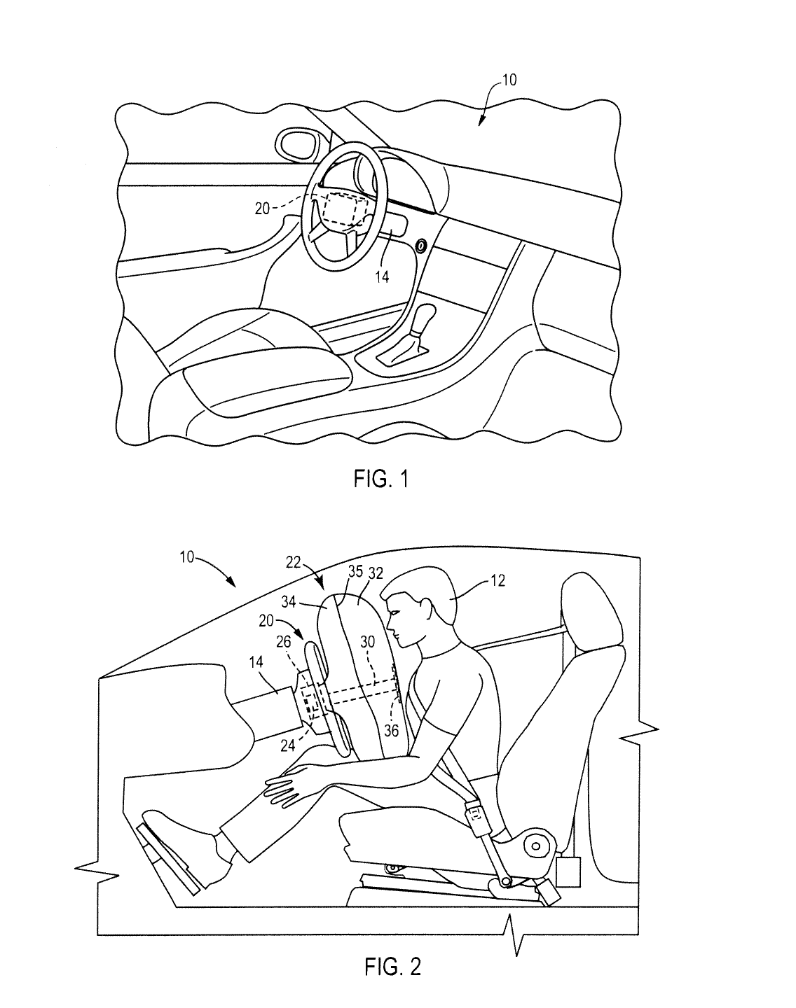

Referring to FIGS. 1 and 2, a vehicle 10 is shown according to an exemplary embodiment. The vehicle 10 includes one or more seats that are configured to receive an occupant 12 and are coupled to the vehicle. Airbags and airbag modules 20 may be provided at a variety of places within the vehicle to protect an occupant of the vehicle in a variety of impact scenarios. For example, airbags may be provided in the dashboard, proximate to the steering wheel, in the vehicle seats, in the door trim panels, in the headliner, etc. According to one exemplary embodiment, shown in FIG. 1, the airbag module 20 is a driver front airbag that is coupled to the steering column 14. However, the airbag module, as described below, may be adapted to be provided at a variety of different locations within the interior of the vehicle such as a passenger front airbag, a side curtain airbag, a knee airbag, a center side-impact airbag, etc.

According to an exemplary embodiment, the airbag module 20 of FIG. 2 includes an inflator (e.g., gas generator) 24 and an airbag cushion 22 that is contained in an uninflated state in a housing 26. The airbag module 20 further includes one or more tethers 30 that are coupled to the cushion in such a way as to control deployment of the cushion 22, such as in the rearward direction. The inflator 24, such as a pyrotechnic gas generator, generates a gas that rapidly inflates the airbag cushion 22 in an impact or vehicle collision. The gas may be generated through pyrotechnic ignition, stored gas or combination thereof. A diffuser (not shown) may be provided to diffuse the gas into the airbag cushion 22 to properly inflate the cushion and preserve the integrity of the cushion fabric. The diffuser is configured to diffuse the inflating gas and trap any particulate byproduct generated by the inflator 24.

According to one exemplary embodiment, as an inflating gas enters the airbag cushion 22, the airbag cushion 22 bursts through an outer skin or cover of the airbag module 20 and inflates between the occupant 12 of the vehicle and the steering wheel, dashboard, or other structural member of the vehicle. For instance, the airbag cushion 22 may emerge from below the outer covering of the steering wheel, through a cutaway in a trim panel, from behind a trim panel, from a seam between two panels or coverings, etc. According to various embodiments, the airbag module 20 may be configured within a glove box assembly or in other locations within the vehicle, such as beneath trim panels along the roof rail, trim panels along the vertical pillars (e.g., the A-pillar, B-pillar, and C-pillar), with the seat assembly, etc. The airbag module 20 is flexibly configurable for use in varying package requirements, and may be tailored to satisfy specific needs of the vehicle manufacturer.

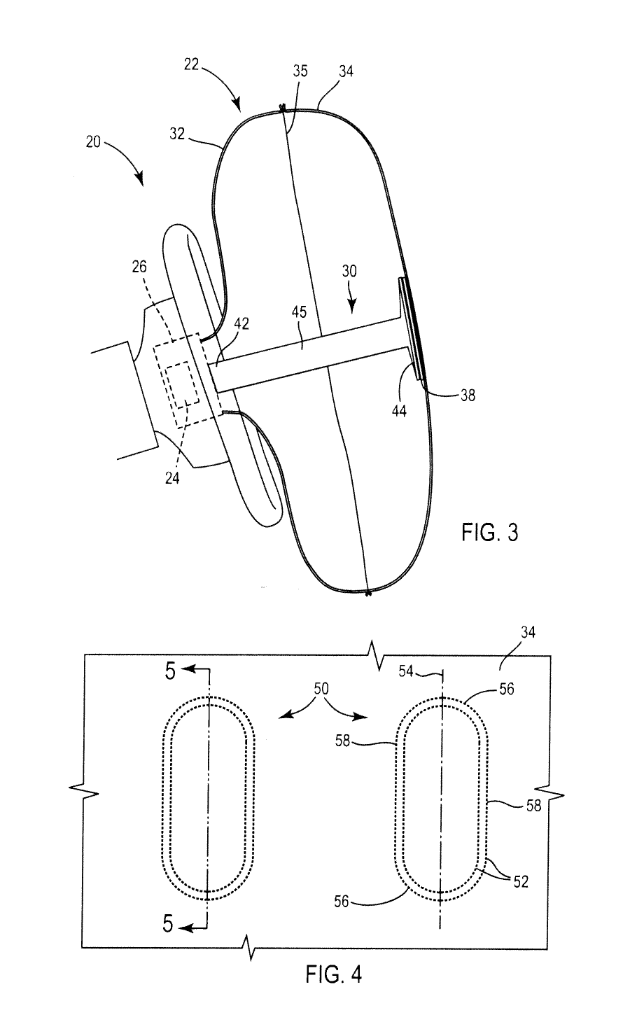

Referring now to FIG. 3, the airbag cushion 22 is shown in more detail. The airbag cushion 22 may be formed of a fabric, such as a woven or non-woven textile (e.g., nylon). The airbag cushion 22 includes a first panel 32 and a second panel 34. The cushion 22 is formed by overlapping the first panel 32 onto the second panel 34 and sewing the periphery of the panels 32 and 34 together, forming an outer seam 35. An interior chamber is formed between the panels 32 and 34 by the seam 35. An aperture formed in the first panel 32, allows inflation gas to enter the interior chamber from the inflator 24. The airbag cushion 22 may be coupled to the inflator 24 and/or the housing 26, such as with bolts passing through the first panel 32 around the periphery of the aperture. One or more vent holes may be formed on the upper portion of the airbag cushion 22 to discharge gas from inside the airbag cushion 22.

The tether 30 extends generally between the first panel 32 and the second panel 34. The tether 30 may be formed of a similar fabric as the cushion 22. According to an exemplary embodiment, airbag module 20 includes a pair of tethers 30 of equal length, each of which includes a first end portion 42 that is coupled to the first panel 32 and a second end portion 44 that is coupled to the second panel 34. The tethers 30 have a length that is less than the untethered depth of the airbag cushion 22. The tethers 30 therefore reduce the depth of the cushion 22 when inflated, reducing the ingress of the cushion 22 into the space occupied by the occupant 12.

The first end portion 42 may be coupled directly to the first panel 32, or may be secured to the inflator retainer. For example, the first end portion 42 may include one or more openings for the same bolts that secure the first panel to the retainer. In addition, the first end portion 42 may be connected directly to the first panel by a seam, for example.

According to an exemplary embodiment, the airbag cushion 22, further includes a reinforcement layer 38 coupled together with the second end 44 of the tether 30 and the second panel 34 of the airbag cushion 22 (e.g., sandwiched between the second panel 34 and the second end portion 44). The reinforcement layer 38 may be formed of a similar fabric as the cushion 22. The reinforcement layer 38 is smaller than the second panel 34. The reinforcement layer 38 is configured to reinforce the second panel 34, to reduce deformation of the expanding airbag cushion 22 caused by the high pressure of the gas injected by the inflator 24, thereby improving the deployment of the airbag module 20.

Referring now to FIGS. 4-6, the second end portion 44 of the tether 30 is shown coupled to the second panel 34 with a sewn seam 50. As shown, the second end portion 44 may have a width that is larger than the width of the main body 45 of the tether 30 that extends between the first end portion 42 and the second end portion 44. According to an exemplary embodiment, the sewn seam 50 is formed by two parallel stitches 52. The seam 50 passes through the second panel 34, the reinforcement panel 38, and the second end portion 44.

The seam 50 is an elongated along an axis 54 (e.g., a vertical axis). As shown in FIG. 4, when the cushion is inflated the elongated axis 54 of the seams 50 extend in the vertical direction of the vehicle and inflated airbag. Preferably, the direction of the axis 54 is parallel to the axis of the spine occupant as shown in FIG. 2. When the airbag cushion 22 is inflated, the tether 30 applies a force pulling on the second panel 34 that opposes an outward pressure applied to the second panel 34 by the inflation gasses. The elongated shape of the seam 50 improves the stress distribution in the second panel 34, reducing stress concentrations that may cause the second panel 34 to rupture during inflation of the cushion 22. In one embodiment, the seam 50 is elongated such that it includes a pair of curved ends 56 that are joined by a pair of parallel sides 58. In other embodiments, the seam 50 may be elongated and otherwise shaped, such as an ellipsoid shape, oval or other closed curve. The seam 50 is preferably symmetrical about its elongated axis in order to reduce the stress concentrations on the seam. Such preferential symmetrical shapes include substantially oval an ellipsoid shapes.

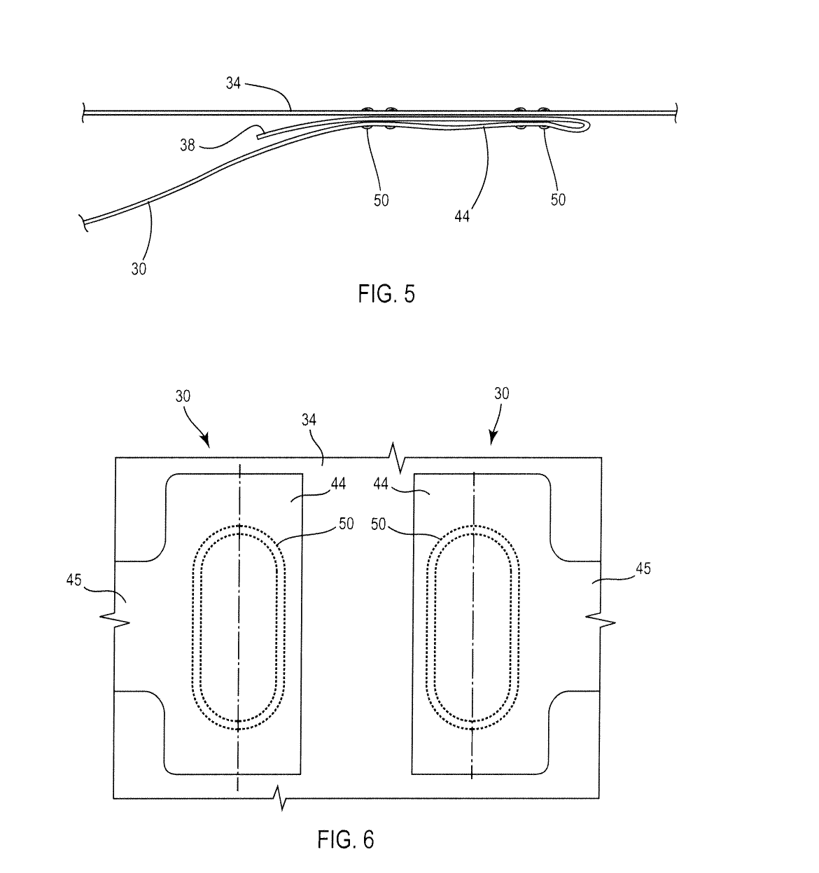

According to an exemplary embodiment, the reinforcing panel 38 is integrally formed with the tether 50 as an extended portion of the second end portion 44. As shown in FIG. 5, the second end portion 44 is folded over on itself. In other embodiments, the reinforcing panel 38 may be formed as a separate panel that is aligned with the second end portion 44 and coupled to the second end portion 44 and the second panel 34 with the seam 50.

The elongated shape of the seam 50 allows the second end portion 44 to be smaller compared to the end portion of the tether configured to be coupled to the second panel 34 with a circular seam. Additionally, the elongated seam 50 and the relatively narrow second end portion 44 of the tether 30 allows for a more efficient packaging of the cushion 22 in an uninflated state (e.g., inside the housing 26).

In other embodiments, the airbag module 20 may have a single tether 30 or more than two tethers 30. The shape and position of the tether 30, as shown in FIGS. 2 and 3, is exemplary only. In other embodiments, the elongated shaped seam 50 may be advantageously utilized to couple tethers of other configurations to the airbag cushion 22. The elongated seam 50 may be utilized for airbag modules having dual stage inflators or single stage inflators.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with interaction the two components or the two components and any additional member being attached to one another. Such joining may be permanent in nature or alternatively may be removable or releasable in nature.

It is important to note that the construction and arrangement of the airbag module as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosure herein. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the exemplary embodiments.

What is claimed is:

1. An airbag module for protecting an occupant of a vehicle comprising:
an inflatable airbag having a front face configured to contact the occupant when the airbag is deployed and a rear face;
an inflator for providing gas to inflate the airbag;
a tether for restraining the deployment of the airbag;
wherein the tether comprises a strap connected at a first end at a location proximate to the inflator and connected at a second end to the front face; and
wherein the tether is connected to the front face by a seam elongated in one direction.

2. The module of claim 1, wherein the seam includes a pair of stitches extending along the entire length of the seam.

3. The module of claim 1, wherein the seam is a closed curve.

4. The module of claim 1, further comprising a reinforcement panel positioned between the second end of the tether and the front face.

5. The module of claim 4, wherein the reinforcement panel is connected to the front face by the seam.

6. The module of claim 5, wherein the reinforcement panel is integrally formed with the second end of the tether and the tether is folded over between the second end and the reinforcement panel so that the reinforcement panel is positioned between the second end and the front face.

7. The module of claim 1, wherein the width of the strap at a location between the first end and the second end is less than the width of the strap at the second end.

8. The module of claim 1, further comprising a second tether configured substantially the same as the first tether and positioned opposite and symmetrically to the first tether.

9. The module of claim 8, wherein each of the tethers are positioned so that when the airbag is inflated the tether extends away from the first end toward the second end and the second ends of each of the tethers are closer together than locations of the strap located between the second and first ends of the tethers.

10. An airbag for protecting an occupant of a vehicle comprising:
a rear panel and a front panel, wherein the front panel is configured to make contact with the occupant when the airbag inflates and the rear panel includes an opening to allow inflation of the airbag, and wherein the rear panel and the front panel are connected together along their peripheries to form an inflatable chamber;
a tether for restraining the deployment of the airbag, wherein the tether is positioned inside the inflatable chamber and includes a strap anchored at a first end at a location proximate to the opening and wherein the strap is connected at a second end to the front panel; and
wherein the second end of the tether is connected to the front panel by a curved seam elongated in one direction.

11. The airbag of claim 10, wherein the shape of the seam is a closed curve that is symmetrical about an elongated axis.

12. The airbag of claim 10, wherein the seam includes a pair of stitches that extend the length of the seam.

13. The airbag of claim 10, further comprising a reinforcement panel positioned between the second end of the tether and the front panel.

14. The airbag of claim 13, wherein the reinforcement panel is connected to the front panel by the seam.

15. The airbag of claim 14, wherein the reinforcement panel is integrally formed with the second end of the tether and the tether is folded over between the second end and the reinforcement panel so that the reinforcement panel is positioned between the second end and the front panel.

16. An airbag module for protecting an occupant of a vehicle comprising:
an inflatable airbag having a front panel configured to contact the occupant when the airbag is deployed and a rear panel including an opening, wherein the front panel and the rear panel are connected together along the periphery of each of the panels to form an inflatable chamber;
an inflator for providing gas to inflate the airbag, wherein the opening surrounds the inflator;
a tether for restraining the deployment of the airbag;
wherein the tether is located in the inflatable chamber and comprises a strap connected at a first end at a location proximate to the inflator and connected at a second end to the front panel; and
wherein the tether is connected to the front panel by a curved seam elongated in one direction.

17. The module of claim 16, wherein the shape of the seam is a closed curve.

18. The module of claim 16, further comprising a reinforcement panel positioned between the second end of the tether and the front panel.

19. The module of claim 18, wherein reinforcement panel is integrally formed with the second end of the tether and the tether is folded over between the second end and the reinforcement panel so that the reinforcement panel is positioned between the second end and the front panel, and wherein the reinforcement panel is connected to the front panel by the seam.

20. The module of claim 19, further comprising a second tether configured substantially the same as the first tether and positioned opposite and symmetrically to the first tether.
